(19) United States
(12) Patent Application Publication
(10) Pub. No.: US 2017/0369729 A1
(43) Pub. Date: Dec. 28, 2017

(54) PRIMERLESS HARDCOAT COMPOSITION

(71) Applicant: Momentive Performance Materials Inc., Waterford, NY (US)

(72) Inventor: Wen P. Liao, Clifton Park, NY (US)

(21) Appl. No.: 15/532,603

(22) PCT Filed: Dec. 22, 2015
(86) PCT No.: PCT/US15/67529

§ 371 Date: Jun. 2, 2017

Related U.S. Application Data
(60) Provisional application No. 62/095,084, filed on Dec. 22, 2014.

(51) Int. Cl. C09D 133/08; C09D 5/00; C09D 7/12; C08K 5/5435

(52) U.S. Cl. CPC C09D 133/08; C09D 7/1233; C09D 5/00; C08K 5/5435

(57) ABSTRACT

A coating composition suitable for providing a hardcoat comprising a topcoat and an epoxy modified adhesion promoter. The epoxy modified adhesion promoter comprises, in one embodiment, a molecule with the formula (1):

U-Q-R¹—SiR²_{g}R³_{(3-g)} (1)

wherein Q is —CH₂CH(OH)CH₂—O— or —CH₂CH(OH)CH₂—NR⁴—; U is:
—O—(C₆HₕR²₍₄₋ₕ₎—CR⁵—C₆HₕR²_{(4-b)}—O—H₂CH(OH)CH₂—O)ᵢ—C₆HₕR²₍₄₋ₕ₎—CR⁵—C₆HₕR²₍₄₋ₕ₎—O-J;
where R² is chosen from a C1-C10 alkyl or a substituted or unsubstituted phenyl group; R³ is chosen from an alkoxy, an acetoxy, or a ketoxime radical; R¹ is a C1-C4 alkylene; g is 0-2; h is 0-4; R⁴ is hydrogen or —CH₂CH(OH)CH₂—U—; R⁵ is hydrogen or an alkyl; i is 0-100; and J is H, Q-R¹SiR²ₕR³₍₃₋ₕ₎, or formula (2). The coating composition is suitable for application to a substrate without the use of a primer.

### CROSS-REFERENCE TO RELATED APPLICATIONS

The present application claims priority to and the benefit of U.S. Provisional Application No. 62/095,804, filed on Dec. 23, 2014, the entire disclosure of which is incorporated herein by reference.

### FIELD

The present invention relates to protective coating compositions and coated articles using the same. More particularly, it relates to thermoformable hardcoat compositions that are suitable for use in demanding thermoforming applications.

### BACKGROUND

Transparent thermoplastics have replaced glass in many applications. Some examples of products made from transparent thermoplastics include glazing for buildings, or public transportation vehicles, such as trains, buses, and airplanes, lenses for eye-glasses, and other optical instruments, etc. While thermoplastics are lighter and more shatter resistant than glass, their abrasion resistance is relatively low. Typically, with even ordinary use in the presence of dust, contact with abrasives, cleaning equipment, and weathering, these transparent plastics may be marred or scratched. This lack of surface hardness and abrasion resistance severely restricts the use of transparent thermoplastic materials.

There is a significant body of technology dealing with means of coating transparent thermoplastics to improve the abrasion resistance of these materials. For example, coatings fanned from mixtures of silica, such as colloidal silica or silica gel, and hydrolysable silanes in a hydrolysis medium have been developed to impart scratch resistance. U.S. Pat. Nos. 3,708,225, 3,986,997, 3,976,497, 4,368,235, 4,324,712, 4,624,870 and 4,863,520 describe such compositions and are incorporated herein by reference in their entireties.

One of the most commonly used thermoplastic substrates for this type of hardcoat is polycarbonate because of its strong impact resistance, optical clarity, and poor abrasion resistance. Unfortunately, current hardcoats, and particularly silicone-based hardcoats, generally do not adhere well to polycarbonate substrates. Presently, a primer layer is used to enhance the adhesion of hardcoats to polycarbonate substrates. Therefore, a need exists for a hardcoat with better adhesion properties to various substrate materials.

### SUMMARY

The present technology provides a coating composition suitable for providing a hardcoat. In particular, the present technology provides a coating composition that may be directly adhered to a substrate without the need for a separate primer coating.

In one aspect, the present technology provides a coating composition comprising a coating material and an epoxy modified adhesion promoter.

In one embodiment, the epoxy modified adhesion promoter is a material having the formula (1):

U-Q-R¹—SiR²_{g}R³_{(3-g)} (1)

wherein Q is —CH₂CH(OH)CH₂—O— or —CH₂CH(OH)CH₂—NR⁴—; U is:
—O—(C₆HₕR²₍₄₋ₕ₎—CR⁵—C₆HₕR²_{(4-b)}—O—H₂CH(OH)CH₂—O)ᵢ—C₆HₕR²₍₄₋ₕ₎—CR⁵—C₆HₕR²₍₄₋ₕ₎—O-J;
where R² is independently chosen from a C1-C10 alkyl or a substituted or unsubstituted phenyl group; R³ independently is chosen from an alkoxy, an acetoxy, or a ketoxime radical; R¹ is a C1-C4 alkylene; g is 0-2; h is 0-4; R⁴ is hydrogen or —CH₂CH(OH)CH₂—U—; R⁵ is independently hydrogen or an alkyl; i is 0-100; and J is H, Q-R¹—SiR²ₕR³₍₃₋ₕ₎, or

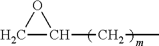

where m is 1-20.

In one embodiment, the adhesion promoter is chosen from:

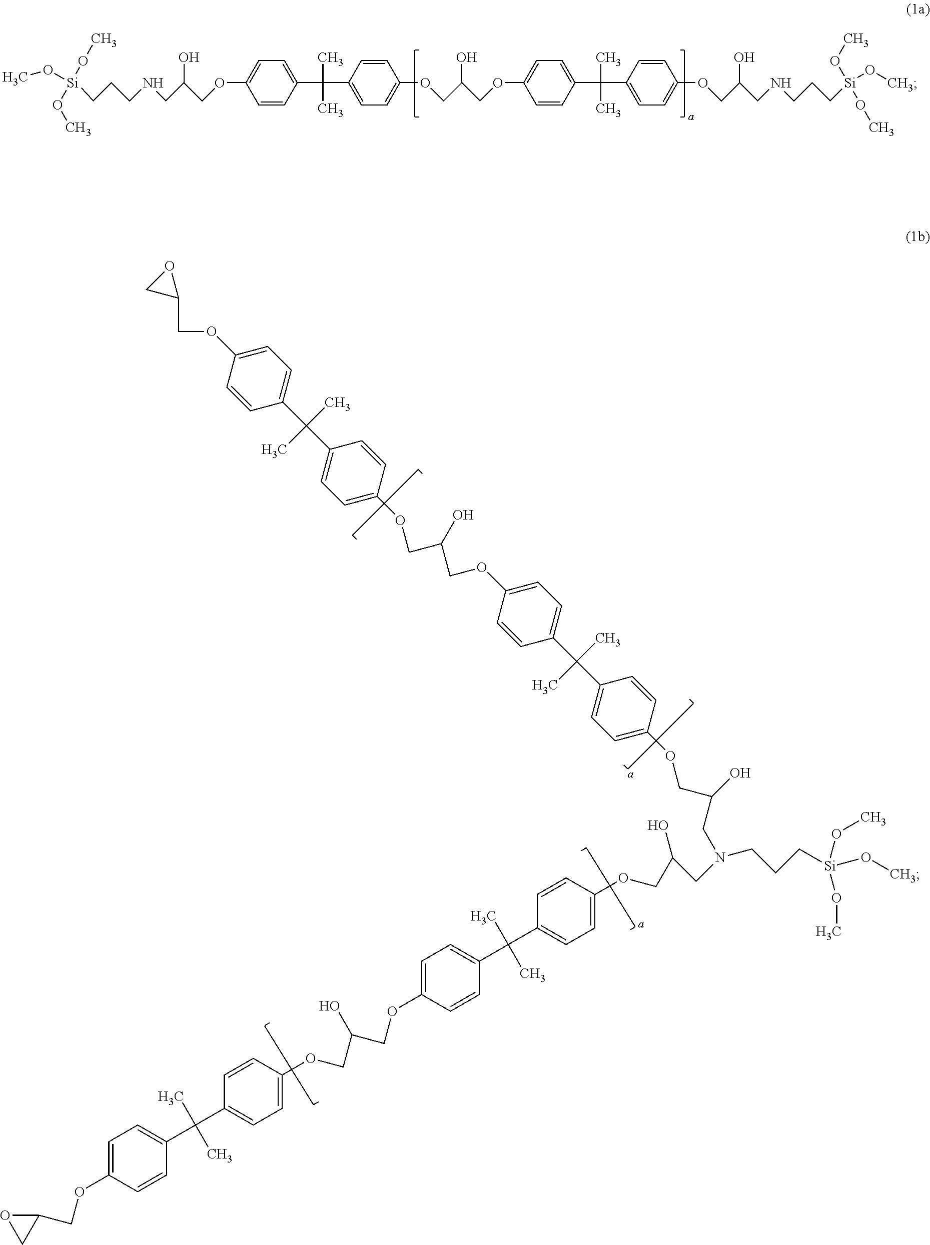

or a combination thereof.

In one embodiment, the topcoat is selected from a silicone topcoat, an acrylic topcoat, a vinyl varnish topcoat, or a combination of two or more thereof

In one embodiment, the coating comprises a siloxanol resin/colloidal silica dispersions.

In one embodiment, the coating composition further comprises a metal oxide.

In one embodiment, the coating composition further comprises a condensation catalyst.

In one embodiment, the coating composition further comprises a leveling agent.

In one embodiment, the coating composition further comprises a silane cross-linker.

In one embodiment, the coating composition further comprises an antioxidant.

In one embodiment, the coating composition further comprises a dye.

In one embodiment, the coating composition further comprises a binder.

In one aspect, the present technology provides an article having at least one surface coated with the coating composition.

In one embodiment, the article comprises a polycarbonate.

In one embodiment, the article comprises a synthetic organic polymer.

In one embodiment, the coating composition has been pre-cured on said surface of said article.

In one embodiment, the coating composition has been pre-cured in the temperature range of 60° C. to 90° C. for 15 to 60 minutes.

In one embodiment, the coating composition has been cured to provide a cured coating on said surface of said article.

In one aspect, the present technology provides a process for preparing a coated article having a partially cured or fully cured coating comprising: (a) applying a coating composition to a substrate, the coating composition comprising a silicone-based coating and an epoxy modified adhesion promoter; and (b) at least partially or fully curing said coating composition, thereby making said coated article having a partially cured or fully cured coating.

In one embodiment, the coating composition is heated at a temperature of from about 60° C. to 90° C. for about 15 to 60 minutes to at least partially cure said coating composition.

In one embodiment, the coated substrate is heated to a temperature of from about 120° C. to about 180° C. to fully cure said coating composition.

In another aspect, the present technology provides an article that is at least partially coated with the coating composition.

### DETAILED DESCRIPTION

The present technology provides a coating composition suitable for forming a hardcoat. The coating composition can exhibit both excellent short term and long term properties such as abrasion resistance. The coatings can be used to coat a variety of substrates and can be used, for example, as a coating to provide abrasion resistance to certain surfaces. Additionally, the coating composition provides a composition that can be adhered to a surface of a substrate without the need for a primer layer to promote adhesion of the coating to the substrate.

The coating composition comprises a coating, e.g., a topcoat, material suitable for forming an abrasion resistant coating and an epoxy modified adhesion promoter. The coating composition may also comprise additional filler components. The coating composition may be configured to provide a relatively hard coating that may provide abrasion resistance and/or other desirable properties to the substrate.

The coating composition comprises an epoxy modified adhesion promoter. In one embodiment, the coating composition comprises an epoxy modified adhesion promoter having at least one molecule with the formula (1):

U-Q-R¹—SiR²_{g}R³_{(3-g)} (1)

wherein Q is —CH₂CH(OH)CH₂—O— or —CH₂CH(OH)CH₂—NR⁴—; U is:
—O—(C₆HₕR²₍₄₋ₕ₎—CR⁵—C₆HₕR²_{(4-b)}—O—H₂CH(OH)CH₂—O)ᵢ—C₆HₕR²₍₄₋ₕ₎—CR⁵—C₆HₕR²₍₄₋ₕ₎—O-J;
where R² is independently chosen from a C1-C10 alkyl or a substituted or unsubstituted phenyl group; R³ is independently chosen from an alkoxy, an acetoxy, or a ketoxime radical; R¹ is a C1-C4 alkylene; g is 0-2; h is 0-4; R⁴ is hydrogen or —CH₂CH(OH)CH₂—U—; R⁵ is independently chosen from hydrogen or an alkyl; i is 0-100; and J is H, Q-R¹—SiR²ₕR³₍₃₋ₕ₎, or formula (2):

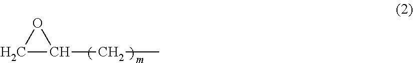

where m is 1-20.

In one embodiment, the epoxy modified adhesion promoter of the formula (1) is an amino functional material that is the reaction product of Epon® 828 from Momentive Specialty Chemicals and Silquest® A-1100 from Momentive Performance Materials having the formula:

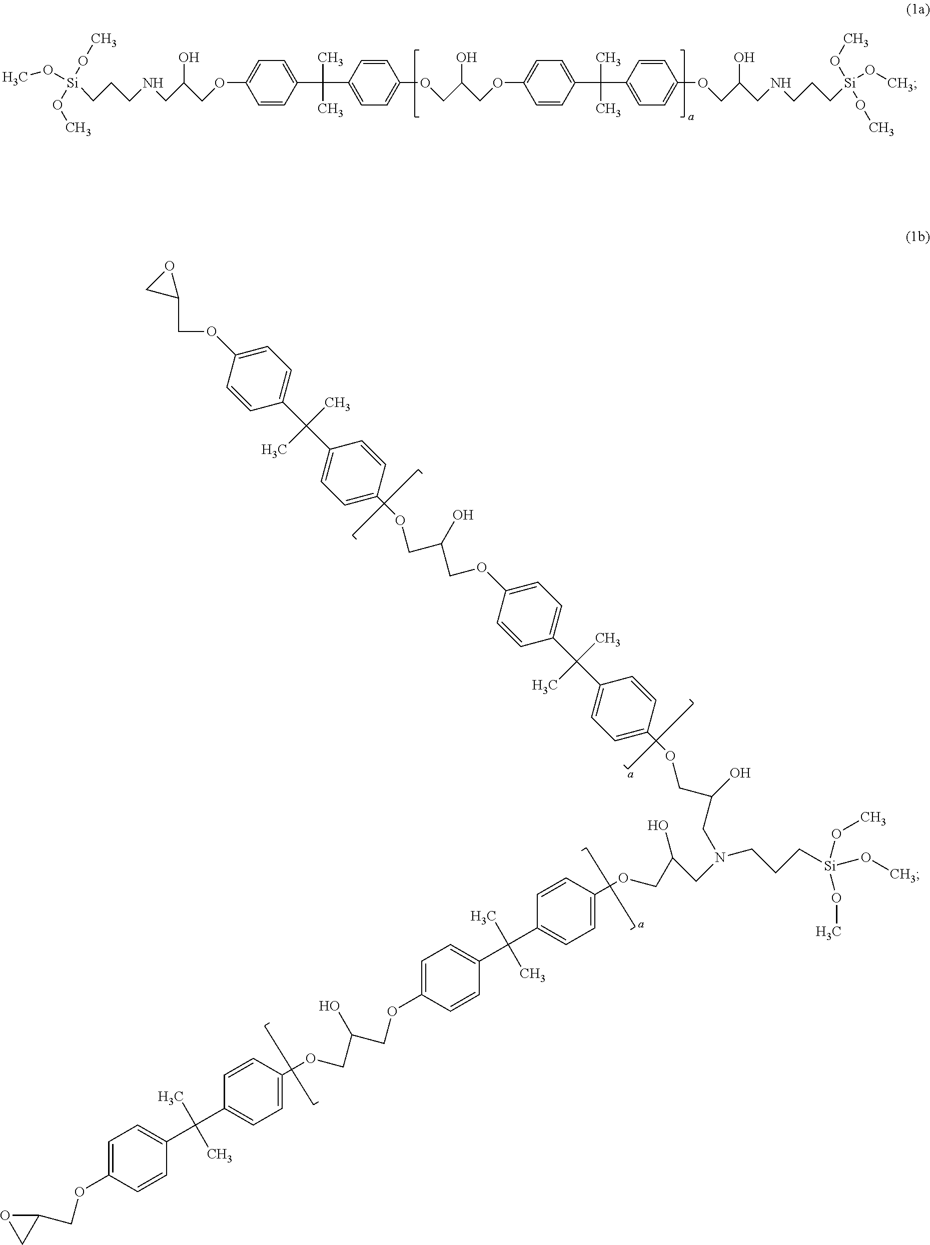

or a combination thereof.

The coating composition can comprise from about 0.1 weight percent to about 50 weight percent of adhesion promoter; from about 0.5 weight percent to about 25 weight percent of adhesion promoter; even from about 1 weight percent to about 5 weight percent of adhesion promoter. In other embodiments, the coating composition comprises the adhesion promoter in an amount of from about 0.1 weight percent to about 1 weight percent, from about 0.2 weight percent to about 0.8 weight percent, even from about 0.3 to about 0.6 weight percent. Here, as elsewhere in the specification and claims, numerical values may be combined to form new and non-disclosed ranges.

The coating composition also comprises a coating material suitable for forming the hardcoat or topcoat coating. The coating material is not particularly limited, and may be comprise any appropriate topcoat, including, but not limited to, a silicone topcoat, an acrylic topcoat, or a vinyl varnish topcoat. One example of silicone coatings that provide a hardcoat is siloxanol resin/colloidal silica dispersions. Siloxanol resin/colloidal silica dispersions are described, for example, in U.S. patent application Ser. No. 13/036,348 and U.S. Pat. No. 8,637,157, the entire disclosures of which are incorporated herein by reference in its entirety.

Siloxanol resin/colloidal silica dispersions are known in the art. Generally, these compositions have a dispersion of colloidal silica in an aliphatic alcohol/water solution of the partial condensate of an alkyltrialkoxysilane, which can be methyltrimethoxysilane. Aqueous colloidal silica dispersions generally have a particle size in the range of 5 to 150 millimicrons in diameter. These silica dispersions are prepared by methods well-known in the art and are commercially available. Depending upon the percent solids desired in the final coating composition, additional alcohol, water, or a water-miscible solvent can be added. Generally, the solvent system should contain from about 20 to about 75 weight percent alcohol to ensure solubility of the siloxanol formed by the condensation of the silanol. If desired, a minor amount of an additional water-miscible polar solvent such as acetone, butyl cellosolve, and the like can be added to the water-alcohol solvent system. The composition is allowed to age for a short period of time to ensure formation of the partial condensate of the silanol, i.e., the siloxanol. Examples of aqueous/organic solvent borne siloxanol resin/colloidal silica dispersions can be found in U.S. Pat. No. 3,986,997 to Clark which describes acidic dispersions of colloidal silica and hydroxylated silsesquioxane in an alcohol-water medium with a pH of about 3-6. Also, U.S. Pat. No. 4,177,315 to Ubersax discloses a coating composition comprising from about 5 to 50 weight percent solids comprising from about 10 to 70 weight percent silica and about 90 to 30 weight percent of a partially polymerized organic silanol of the general formula RSi(OH)₃, wherein R is chosen from methyl and up to about 40% of a radical chosen from the group consisting of vinyl, phenyl, gamma-glycidoxypropyl, and gamma-methacryloxypropyl, and about from 95 to 50 weight percent solvent, the solvent comprising about from 10 to 90 weight percent water and about from 90 to 10 weight percent lower aliphatic alcohol, the coating composition having a pH of greater than about 6.2 and less than about 6.5. U.S. Pat. No. 4,476,281 to Vaughn describes a hardcoat composition having a pH from 7.1-7.8. In another example, U.S. Pat. No. 4,239,798 to Olson et al. discloses a thermoset, silica-filled, organopolysiloxane top coat, which is the condensation product of a silanol of the formula RSi(OH)₃ in which R is chosen from the group consisting of alkyl radicals of 1 to 3 carbon atoms, the vinyl radical, the 3,3,3-trifluoropropyl radical, the gamma-glycidoxypropyl radical and the gamma-methacryloxypropyl radical, at least 70 weight percent of the silanol being CH₃ Si(OH)₃. The content of the foregoing patents are herein incorporated by reference.

The siloxanol resin/colloidal silica dispersions described herein above can contain partial condensates of both organotrialkoxysilanes and diorganodialkoxysilanes; and can be prepared with suitable organic solvents, such as, for example, 1 to 4 carbon alkanol, such as methanol, ethanol, propanol, isopropanol, butanol; glycols and glycol ethers, such as propyleneglycolmethyl ether and the like and mixtures thereof.

Examples of suitable silicone coating materials include, but are not limited to, SilFORT AS4700, SilFORT PHC 587, AS4000, AS4700, SHC2050, SILVUE 121, SILVUE 339, SILVUE MP100, HI-GARD 1080, etc.

The coating composition may optionally comprise a metal oxide. The metal oxide may include, but is not limited to, silica, alumina, titania, ceria, tin oxide, zirconia, antimony oxide, indium oxide, iron oxide, titania doped with iron oxide and/or zirconia, rare earth oxides, and mixtures and complex oxides thereof. Collodial dispersions of such metal oxides in powder form may also be used. Alternatively, metal oxides in powder form may be dispersed in the coating compositions.

In one embodiment, the metal oxide is colloidal silica. The aqueous dispersions of colloidal silica can have an average particle size ranging from 2-150 nm, from 3-100 nm, 4-50 nm, even from 5-30 nm. Here, as elsewhere in the specification and claims, numerical values may be combined to form new and non-disclosed ranges. For example, commercially available dispersions include LUDOX® (DuPont), SNOWTEX® (Nissan Chemical), and BINDZIL® (Akzo Nobel) and NALCOAG® (Nalco Chemical Company). Such dispersions are available in the form of acidic and basic hydrosols.

Both acidic and basic colloidal silica can be used in the present technology. Colloidal silica having a low alkali content provide a more stable coating composition. Some examples of colloidal silica include NALCOAG® 1034A sold by Nalco Chemical Company and SNOWTEX® 040, SNOWTEX® OL-40 sold by Nissan Chemical.

The coating composition may optionally comprise a condensation catalyst which promotes the condensation of completely or partially hydrolyzed topcoat material. The catalyst can be a catalyst suitable for promoting the curing of siloxanes. Advantageously, condensation catalysts can be employed. Suitable condensation catalysts include, but are not limited to, dialkyltin dicarboxylates such as dibutyltin dilaurate and dioctyltin dilaurate, tertiary amines, the stannous salts of carboxylic acids, such as stannous octoate and stannous acetate, etc. Other useful catalysts include zirconium-containing, aluminum-containing, and bismuth-containing complexes such as K-KAT® XC6212, K-KAT® 5218 and K-KAT® 348, supplied by King Industries, Inc., titanium chelates such as the TYZOR® types, available from DuPont company, and the KR types, available from Kenrich Petrochemical, Inc., and other organometallic catalysts, e.g., those containing a metal such as Al, Zn, Co, Ni, Fe, etc. In one embodiment, component (E) is a thermal cure catalyst tetrabutylammonium carboxylate of the formula (5): [(C₄H₉)₄N]⁺[OC(O)—V]⁻, wherein V is selected from the group consisting of hydrogen, C1-C8 alkyl groups, and C6-C20 aromatic groups. In one embodiment, V is a group containing about 1 to 4 carbon atoms, such as methyl, ethyl, propyl, butyl, and isobutyl. Exemplary catalysts of formula (5) include, but are not limited to, tetra-n-butylammonium acetate (TBAA), tetra-n-butylammonium formate, tetra-n-butylammonium benzoate, tetra-n-butylammonium-2-ethylhexanoate, tetra-n-butylammonium-p-ethylbenzoate, and tetra-n-butylammonium propionate.

The coating composition can also include surfactants as leveling agents. Examples of suitable surfactants include, but are not limited to, fluorinated surfactants such as FLUORAD® from 3M Company of St. Paul, Minn., and silicone polyethers under the designation Silwet® and CoatOSil® available from Momentive Performance Materials, Inc. of Albany, N.Y. and BYK available from BYK Chemie USA of Wallingford, Conn.

The coating composition can also comprise a silane cross-linker, antioxidants such as hindered phenols (e.g., IRGANOX® 1010 from Ciba Specialty Chemicals), dyes (e.g., methylene green, methylene blue, etc.) fillers, and other additives.

The coating composition may further comprise a binder. The binder is not particularly limited and can be chosen from any material suitable as a binder. In one embodiment, the binder can be chosen from an epoxy compound, a curable silicon-containing compound, or a combination of two or more thereof. Examples of suitable silicon-containing compounds for the binder include, but are not limited to, curable polysiloxanes. Examples of curable polysiloxanes include, but are not limited to, condensation curable siloxanes or siloxanes curable via hydrosilylation. Examples of suitable siloxanes include, but are not limited to, hydrogen polydimethylsiloxane, hydroxyl functional polydimethylsiloxane, etc. Other suitable siloxanes include amino- or epoxy-functional siloxanes, e.g., amino- or epoxy-functional polydimethylsiloxanes.

Examples of suitable epoxy compounds for the binder include, but are not limited to, Bisphenol A/bisphenol F epoxides; bisphenol A epoxides; epoxy novolac resins; aliphatic epoxy resins; epoxy functional acrylic polymers; epoxy esters; reactive epoxy diluents; combinations of two or more thereof, etc.

The coating composition can be prepared by mixing the hardcoat material and the adhesion promoter. In an embodiment, the adhesion promoter may be a preformed material that is added to the coating material. In another embodiment, the adhesion promoter may be formed in-situ. That is, the components for forming the adhesion promoter may be added to the coating material, and the adhesion promoter may be formed as part of the reaction process in curing the coating composition.

Solvents used for the hydrolytic condensation reaction are usually alcohols, such as methanol, ethanol, propanol, isopropanol, n-butanol, tert-butanol, methoxypropanol, ethylene glycol, diethylene glycol butyl ether, or combinations thereof. Other water miscible organic solvents such as acetone, methyl ethyl ketone, ethylene glycol monopropyl ether, and 2-butoxy ethanol, can also be utilized. Typically, these solvents are used in combination with water.

The temperature for the hydrolysis reaction is generally kept in the range of from about 20° C. to about 50° C., and preferably below 40° C. Here, as elsewhere in the specification and claims, numerical values may be combined to form new and non-disclosed ranges. As a general rule, the longer the reaction time permitted for hydrolysis, the higher the final viscosity.

If necessary, a hydrolysis catalyst may be present during the hydroxylation process. In one embodiment, the hydrolysis catalyst is an acid. Suitable acids include hydrochloric, acetic, chloroacetic, citric, phenylacetic, formic, propionic, glycolic, malonic, toluenesulfonic, and oxalic. The catalyst can be used undiluted or in the form of an aqueous solution.

The coating composition can have a pH in the range of from about 3 to about 9, from about 4 to about 8, even from about 5 to about 7. Here, as elsewhere in the specification and claims, numerical values may be combined to form new and non-disclosed ranges. After the hydrolytic condensation reaction, it may be necessary to adjust the pH of the composition to fall within these ranges. To increase the pH value, volatile bases, such as ammonium hydroxide, may be sued. To lower the pH value, volatile acids, such as acetic acid and formic acid, may be used.

The coating composition can be applied by any suitable methods including, but not limited to, by brush, by roller, by spraying, by dipping, etc. Curing can be accomplished by any suitable curing mechanism including, for example, thermal condensation.

The coating composition can be applied to provide a coating layer of a desired thickness. In one embodiment, the coating composition has a thickness of from 0.5 micrometer to about 500 micrometers; from about 1 micrometers to about 300 micrometers; even from about 3 micrometers to about 200 micrometers. Here, as elsewhere in the specification and claims, numerical values may be combined to form new and non-disclosed ranges.

The coating composition can be used in a variety of applications where scratch-resistance is desired. The coating composition can be suitably coated onto a substrate such as plastic or metal surface without the use of a primer. Examples of such plastics include synthetic organic polymeric materials, such polycarbonate, acrylic polymers, for example, poly(methylmethacrylate), etc.; polyesters, for example, poly(ethylene terephthalate), poly(butylenes terephthalate), etc.; polyamides, polyimides, acrylonitrile-styrene copolymer, styrene-acrylonitrile-butadiene terpolymers, polyvinyl chloride, polyethylene, etc.

Special mention is made of the polycarbonates, such as those polycarbonates known as LEXAN® polycarbonate resin, available from SABIC Innovative Plastics, including transparent panels made of such materials. The compositions of this invention are especially useful as protective coatings on the surfaces of such articles.

Once the coating composition of the present technology is coated on a substrate, it is allowed to dry by removal of any solvents, for example by evaporation, thereby leaving a dry coating.

The coating composition can subsequently be cured at a temperature of from about 50° C. to about 180° C. If a thermoforming process is desired, it is advantageous to pre-cure the coating composition. In a pre-curing step, the air-dried coating is subjected to slightly elevated temperature with relatively short exposure time to provide a pre-cured coating.

A suitable pre-curing condition can be determined by subjecting the coated articles to various pre-curing temperatures for various durations, and then thermoforming the parts at from about 100° C. to about 300° C. for 5 to 30 minutes, even at from about 150-180° C. for 5 to 30 minutes. Here, as elsewhere in the specification and claims, numerical values may be combined to form new and non-disclosed ranges. An optimized condition is selected when the thermoformed parts do not have any micro-cracking while at the same time exhibit a superior taber abrasion resistance. While the invention has been described with reference to various exemplary embodiments, it will be appreciated that modifications may occur to those skilled in the art, and the present application is intended to cover such modifications and inventions as fall within the spirit of the invention.

The following examples are illustrative and not to be construed as limiting of the technology as disclosed and claimed herein.

### EXAMPLES

### Coating Procedure

A 4 inch by 6 inch polycarbonate plaque (Lexan® from Siabic) was cleaned with isopropanol and air dried. The liquid coating material was then flowed coated onto the cleaned plaque. The excess coating material was allowed to drain while maintaining the plaque vertically. The coating was allowed to air dry for at least five minutes before being cured in an oven for one hour at 120° C.

### Adhesion Test Procedure

The adhesion was measured using a cross-hatch adhesion test according to ASTM D3359. The adhesion is rated on a scale of 5B-0B, with 5B indicative of the highest adhesion of coating and OB indicative of total loss of coating.

### Examples 1a and 1b

EPON® 828 from Momentive Specialty Chemicals, Silquest A-1100 from Momentive Performance Materials, and xylene were added to a 3-neck round bottom flask equipped with a thermometer, a condenser, and a nitrogen inlet in the amounts specified in Table 1 below. The solution was purged with nitrogen gas and then heated to 80° C. for six hours.

TABLE 1
Adhesion Promoters (weight in grams)

| | Ex. 1a | Ex. 1b |
|---|---|---|
| EPON 828 | 34 | 34 |
| Silquest A-1100 | 10.5 | 47 |
| Xylene | 68 | 70.3 |
| A1100/Epon 828 (Molar ratio) | 0.47 | 2.12 |

### Example 2

EPON® 828 from Momentive Specialty Chemicals, Silquest A-1100 from Momentive Performance Materials, and xylene were added to a 3-neck round bottom flask equipped with a thermometer, a condenser, and a nitrogen inlet in the amounts specified in Table 2 below. The solution was purged with nitrogen gas and then heated to 80° C. for six hours.

TABLE 2
Adhesion Promoters (weight in grams)

| | Ex. 2a | Ex. 2b | Ex. 2c | Ex. 2d | Ex. 2e |
|---|---|---|---|---|---|
| EPON 828 | 18.2 | 13.8 | 12.17 | 9.83 | 10.02 |
| Silquest A-1100 | 14.7 | 13.7 | 13.76 | 12.9 | 14.78 |
| A1100/Epon 828 (Molar | 1.24 | 1.53 | 1.74 | 2.02 | 2.27 |
| ratio) | | | | | |

### Examples 3 and 4

The coating formation was blended under ambient conditions according to Table 3. After curing at 120° C. for one hour, the adhesion was estimated according to ASTM D3359. To estimate long term performance, an adhesion test was also conducted on some of the coated samples that had been immersed in 65° C. water bath for 17 days. The results are shown in Tables 3 and 4 below.

TABLE 3
Primerless Hardcoat Formulas and Adhesion to Polycarbonate (weight in grams)

| | Example | | | | | | | | | | | |
|---|---|---|---|---|---|---|---|---|---|---|---|---|
| | Ex. | Ex. | Ex. | Ex. | Ex. | Ex. | Ex. | Ex. | Ex. | Ex. | Ex. | Ex. |
| | 3a | 3b | 3c | 3d | 3e | 3f | 3g | 3h | 3i | 3j | 3k | 3l |
| SHC5020 | 15 | 15 | | | | | | | | | | |
| AS4700 | | | 15 | 15 | | | | | | | | |
| AS4010 | | | | | 15 | 10 | 10 | 10 | | | | |
| FHC615 | | | | | | | | | 10 | 10 | 10 | 10 |
| Ex. 1a | 0.3 | | 0.3 | | 0.3 | 0.4 | 0.6 | 0.8 | 0.2 | 0.4 | 0.6 | 0.8 |
| Ex. 1b | | 0.3 | | 0.3 | | | | | | | | |
| Total | 15.3 | 15.3 | 15.3 | 15.3 | 15.3 | 10.4 | 10.6 | 10.8 | 10.2 | 10.4 | 10.6 | 10.8 |
| % adhesion promoter | 0.8 | 1.0 | 0.8 | 1.0 | 0.8 | 1.5 | 2.2 | 2.9 | 0.8 | 1.5 | 2.2 | 2.9 |
| Crosshatch scratch | 5B | 5B | 5B | 0B | 3B | 5B | 5B | 5B | 5B | 5B | 5B | 5B |
| adhesion (ASTM3359) | | | | | | | | | | | | |
| Crosshatch scratch after | | | | | | | | | 5B | 5B | 5B | 5B |
| 65° C. water soak | | | | | | | | | | | | |

TABLE 4
Primerless Hardcoat Formulas and Adhesion to Polycarbonate (weight in grams)

| | Example | | | | | | | | | | | | | | |
|---|---|---|---|---|---|---|---|---|---|---|---|---|---|---|---|
| | Ex. | Ex. | Ex. | Ex. | Ex. | Ex. | Ex. | Ex. | Ex. | Ex. | Ex. | Ex. | Ex. | Ex. | Ex. |
| | 4a | 4b | 4c | 4d | 4e | 4f | 4g | 4h | 4i | 4j | 4k | 4l | 4m | 4n | 4p |
| SHC5020 | 30 | 30 | 30 | 30 | 30 | | | | | | | | | | |
| AS4010 | | | | | | 30 | 30 | 30 | 30 | 30 | | | | | |
| FHC615 | | | | | | | | | | | 30 | 30 | 30 | 30 | 30 |
| Ex. 2a | 0.6 | | | | | 0.6 | | | | | 0.6 | | | | |
| Ex. 2b | | 0.6 | | | | | 0.6 | | | | | 0.6 | | | |
| Ex. 2c | | | 0.6 | | | | | 0.6 | | | | | 0.6 | | |
| Ex. 2d | | | | 0.6 | | | | | 0.6 | | | | | 0.6 | |
| Ex. 2e | | | | | 0.6 | | | | | 0.6 | | | | | 0.6 |
| Total | 30.6 | 30.6 | 30.6 | 30.6 | 30.6 | 30.6 | 30.6 | 30.6 | 30.6 | 30.6 | 30.6 | 30.6 | 30.6 | 30.6 | 30.6 |
| % adhesion | 2.0 | 2.0 | 2.0 | 2.0 | 2.0 | 2.0 | 2.0 | 2.0 | 2.0 | 2.0 | 2.0 | 2.0 | 2.0 | 2.0 | 2.0 |
| promoter | | | | | | | | | | | | | | | |
| Crosshatch scratch | 5B | 5B | 5B | 5B | 5B | 5B | 5B | 5B | 5B | 5B | 5B | 5B | 5B | 5B | 5B |
| adhesion | | | | | | | | | | | | | | | |
| (ASTM3359) | | | | | | | | | | | | | | | |

The test results show that the present technology enables the adhesion of hardcoats to a substrate, such as polycarbonate, without the use of a separate primer layer.

While the above description contains many specifics, these specifics should not be construed as limitations on the scope of the invention, but merely as exemplifications of preferred embodiments thereof. Those skilled in the art may envision many other possible variations that are within the scope and spirit of the invention as defined by the claims appended hereto.

1. A coating composition suitable for providing a hardcoat comprising a topcoat material and an epoxy modified adhesion promoter.

2. The coating of claim 1, wherein the epoxy modified adhesion promoter has at least one molecule with the formula (1):
U-Q-R¹—SiR²_{g}R³_{(3-g)} (1)
wherein Q is —CH₂CH(OH)CH₂—O— or —CH₂CH(OH)CH₂—NR⁴—; U is:
—O—(C₆HₕR²₍₄₋ₕ₎—CR⁵—C₆HₕR²_{(4-b)}—O—H₂CH(OH)CH₂—O)ᵢ—C₆HₕR²₍₄₋ₕ₎—CR⁵—C₆HₕR²₍₄₋ₕ₎—O-J;
where R² is independently chosen from a C1-C10 alkyl or a substituted or unsubstituted phenyl group; R³ is independently chosen from an alkoxy, an acetoxy, or a ketoxime radical; R¹ is a C1-C4 alkylene; g is 0-2; h is 0-4; R⁴ is hydrogen or —CH₂CH(OH)CH₂—U—; R⁵ is independently chosen from hydrogen or an alkyl; i is 0-100; and J is H, Q-R¹SiR²ₕR³₍₃₋ₕ₎, or 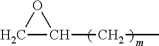
where m is 1-20.

3. The coating composition of claim 2, wherein the adhesion promoter is chosen from: 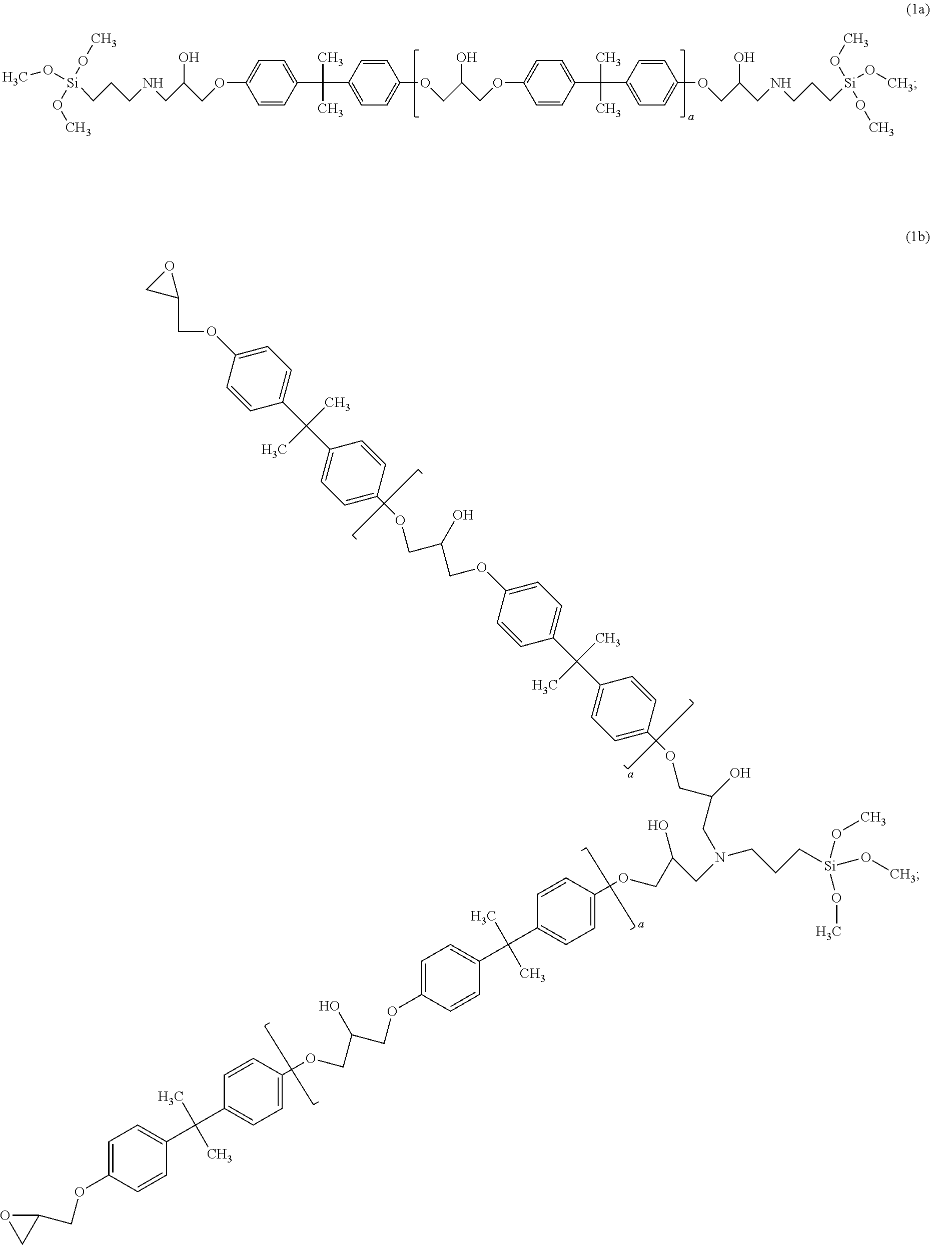
or a combination thereof

4. The coating composition of claim 1, wherein the adhesion promoter is present in an amount of from about 0.1 to about 50 weight percent based on the weight of the composition.

5. The coating composition of claim 1, wherein the adhesion promoter is present in an amount of from about 0.1 to about 1 weight percent based on the weight of the composition.

6. The coating composition of claim 1, wherein the topcoat is selected from a silicone topcoat, an acrylic topcoat, a vinyl varnish topcoat, or a combination of two or more thereof.

7. The coating composition of claim 6, wherein the silicone topcoat comprises a siloxanol resin/colloidal silica dispersions.

8. The coating composition of claim 1 further comprising a metal oxide.

9. The coating composition of claim 1 further comprising a condensation catalyst.

10. The coating composition of claim 1 further comprising a leveling agent.

11. The coating composition of claim 1 further comprising a silane cross-linker.

12. The coating composition of claim 1 further comprising an antioxidant.

13. The coating composition of claim 1 further comprising a dye.

14. The coating composition of claim 1 further comprising a binder.

15. An article having a surface comprising a coating of the coating composition of claim 1 disposed on at least a portion of the surface.

16. The article of claim 15, wherein the article comprises a polycarbonate, an acrylic polymer, a polyester, a polyamide, a polyimide, an acrylonitrile-styrene copolymer, a styrene-acrylonitrile-butadiene terpolymer, a polyvinyl chloride, a polyethylene, or a combination of two or more thereof.

17. The article of claim 15, wherein said coating composition has been pre-cured on said surface of said article.

18. The article of claim 17, wherein said coating composition has been pre-cured in the temperature range of 60° C. to 90° C. for 15 to 60 minutes.

19. The article of claim 18, wherein said coating composition has been cured to provide a cured coating on said surface of said article.

20. The article of claim 15, wherein the article is free of a primer layer between the coating and the surface of the article.

21. A process for preparing a coated article having a partially cured or fully cured coating comprising applying a coating composition of claim 1 to at least a portion of a surface of a substrate; and at least partially curing the composition to form a hardcoat layer.

22. The process of claim 21, wherein said coating composition is heated at a temperature of from about 60° C. to 90° C. for about 15 to 60 minutes to at least partially cure said coating composition.

23. The process of claim 22, wherein said coated substrate is heated to a temperature of from about 160° C. to about 180° C. to fully cure said coating composition.
